(19) United States
(12) Patent Application Publication
(10) Pub. No.: US 2026/0019752 A1
(43) Pub. Date: Jan. 15, 2026

(54) MULTIFUNCTIONAL SOUND GENERATING DEVICE

(71) Applicant: AAC Microtech (Changzhou) Co., Ltd., Changzhou City (CN)

(72) Inventors: Bo Xiao, Changzhou (CN); Ronglin Linghu, Changzhou (CN); Weiwei Tao, Changzhou (CN); Fan Zhang, Changzhou (CN)

(21) Appl. No.: 19/000,599

(22) Filed: Dec. 23, 2024

Related U.S. Application Data
(63) Continuation of application No. PCT/CN2024/105003, filed on Jul. 11, 2024.

(51) Int. Cl. H04R 9/06

(52) U.S. Cl. CPC H04R 9/06

(57) ABSTRACT

Embodiments of the disclosure relate in general to the field of electro-acoustic conversion technologies, and provide a multifunctional sound generating device, which includes a housing, a sound generating unit, and at least one elastic member. The sound generating unit includes a basin frame, a vibration system, and a magnetic circuit system configured to drive the vibration system to vibrate and output sound. The housing defines an opening. The multifunctional sound generating device further includes a driving coil fixed to the housing, and the driving coil interacts with the magnetic circuit system to drive the sound generating unit to move back and forth in a direction perpendicular to a vibration direction of the vibration system. Compared with the related technologies, the multifunctional sound device of the present invention has a simple overall structure, good vibration effect, and better acoustic performance.

### CROSS REFERENCE TO RELATED APPLICATIONS

The present application is a continuation of PCT Patent Application No. PCT/CN2024/105003, filed July 11, 2024, which is incorporated by reference herein in its entirety.

### TECHNICAL FIELD

The various embodiments described in this document relate in general to the field of electro-acoustic conversion technologies, and more specifically to a multifunctional sound generating device applied to electronic motor products.

### BACKGROUND

With the advent of the mobile Internet era, the number of intelligent mobile devices is increasingly increased. Mobile phones are undoubtedly the most common and portable mobile terminal devices among the intelligent mobile devices. At present, mobile phones have extremely diverse functions, such as high-quality music functions and vibration functions. Therefore, multifunctional sound generating devices with vibration functions and playing sounds are widely used in current intelligent mobile devices.

The multifunctional sound generating device in related technologies includes a housing and a motor vibration system received in the housing. The motor vibration system includes a sound generating unit fixed on the housing, a mass block fixed on the sound generating unit, and a driving coil for driving the sound generating unit to vibrate. The sound generating unit is suspended in the housing by an elastic member, and the driving coil is energized and mutually driven with the sound generating unit to realize the function of vibration and sound-generation.

However, in the related technologies, the vibration performance of the vibration motor is improved by adding a mass block. However, when a material density of the mass block is relatively low, the overall volume of the mass block is too large, occupying a relatively large installation space. In addition, the sound generating unit is fixed on and supported by the housing, which has poor vibration buffering effect and poor acoustic performance.

Therefore, there is a need to provide a new multifunctional sound generating device to solve the above technical problems.

### SUMMARY

The disclosure aims to provide a multifunctional sound generating device with simple structure, good vibration effect, and better acoustic performance.

In view of the above, a multifunctional sound generating device is provided and includes a housing having a receiving space, a sound generating unit received in the receiving space, and at least one elastic member configured to movably support the sound generating unit in the housing. The sound generating unit includes a basin frame, a vibration system fixed to a side of two opposite sides of the basin frame, and a magnetic circuit system fixed to another side of the two opposite sides of the basin frame, wherein the magnetic circuit system is configured to drive the vibration system to vibrate and output sound, and the housing defines an opening for outputting the sound of the sound generating unit. The multifunctional sound generating device further includes a driving coil fixed to the housing, and the driving coil interacts with the magnetic circuit system to drive the sound generating unit to move back and forth in a direction perpendicular to a vibration direction of the vibration system.

In some embodiments, the vibration system includes a diaphragm fixed to the basin frame and a vibrating voice coil configured to drive the diaphragm to vibrate, the multifunctional sound generating device further includes an annular sealing film, and the sealing film is connected to the housing and the sound generating unit, and wherein the diaphragm, the sealing film, and the housing cooperatively define a closed rear cavity, and the sealing film is deformable on condition that the sound generating unit moves back and forth in the direction perpendicular to the vibration direction of the vibration system.

In some embodiments, the sealing film has hardness less than 30A.

In some embodiments, the sealing film is made of at least one of silica gel, rubber, and elastomer.

In some embodiments, the housing includes an annular frame, a bottom wall formed by bending and extending one end of the frame in a direction close to the sound generating unit, and an avoidance space formed by running through one side surface of the frame. The sealing film has a side that is close to the bottom wall fixed to the bottom wall, and has another side that is close to the avoidance space fixed to the frame.

In some embodiments, the sealing film includes an annular sealing film body fixed to the bottom wall, an annular support portion formed by extending from one end of the sealing film body away from the bottom wall, and a step portion formed by recessing from a side of the support portion close to the sound generating unit in a direction away from the sound generating unit. The support portion bends and extends in a direction toward the avoidance space at a portion of the support portion corresponding to the avoidance space to form a bent portion, and the bent portion is fixed to the frame at an end of the bent portion away from the sound generating unit.

In some embodiments, the multifunctional sound generating device further includes an annular sealing ring, and the sealing ring has an inner side fixed to the sound generating unit and has an outer side fixed to the sealing film.

In some embodiments, the sealing ring includes an annular sealing ring body fixed to the step portion, a first connection portion formed by bending and extending from an end of the sealing ring body close to the bottom wall toward the sound generating unit, and a second connection portion formed by bending and extending from another end of the sealing ring body away from the bottom wall toward the frame. The first connection portion is fixed to the sound generating unit, and the second connection portion is fixed to an end of the support portion away from the sealing film body.

In some embodiments, the first connection portion is fixed to the diaphragm, and the sealing ring body extends along the vibration direction of the vibration system and is spaced apart from the basin frame in the direction perpendicular to the vibration direction of the vibration system.

In some embodiments, the sealing film and the housing are integrally formed or fixedly connected by adhesive bonding.

In some embodiments, the multifunctional sound generating device further includes a conductive member, where the conductive member is connected with at least one of the driving coil and the vibrating voice coil, and configured to introduce an external electrical signal for the at least one of the driving coil and the vibrating voice coil.

In some embodiments, the conductive member includes a first conductive member and a second conductive member, the first conductive member has an end that is fixed to the driving coil and forms an electrical connection with the driving coil, and has the other end that extends to outside of the housing for connecting external devices. The second conductive member has an end that is fixed to the vibrating voice coil and forms an electrical connection with the vibrating voice coil, and has another end that extends to the outside of the housing for connecting external devices.

Compared with the related technologies, in the multifunctional sound generating device of the present disclosure, the sound generating unit is movably supported in the housing by the elastic members, and the housing defines the opening for outputting sound of the sound generating unit. The multifunctional sound generating device further includes the driving coil fixed on the housing, the driving coil interacts with the magnetic circuit system to drive the sound generating unit to move back and forth in the direction perpendicular to the vibration direction of the vibration system to realize the vibration of the sound generating unit. In addition, the mass effect of the motor vibrator is provided by using the weight of the sound generating unit to save the overall installation space. By connecting the sealing film with the housing and the sound generating unit, the closed rear cavity is formed between the diaphragm, the sealing film, and the housing. The sealing film can deform when the sound generating unit moves back and forth in the direction perpendicular to the vibration direction of the vibration system, so that the sealing film can not only deform, but also play the role of isolating the air and sound pressure in the front cavity and the rear cavity, further improving the acoustic performance of the multifunctional sound generating device.

### BRIEF DESCRIPTION OF THE DRAWINGS

In order to more clearly explain the technical solutions in embodiments of the present disclosure, the accompanying drawings that need to be used in the description of the embodiments will be briefly introduced below, and it is obvious that the accompanying drawings in the following description are only some embodiments of the present disclosure, and other accompanying drawings can be obtained from these accompanying drawings without making creative effort for those skilled in the art

FIG. 1 is a schematic diagram of a three-dimensional structure of a multifunctional sound generating device according to an embodiment of the present disclosure.

FIG. 2 is a three-dimensional exploded view of a multifunctional sound generating device according to an embodiment of the present disclosure.

FIG. 3 is a cross-sectional view taken along line A-A of FIG. 1.

FIG. 4 is a sectional view taken along line B-B of FIG. 1.

FIG. 5 is a partial enlarged view of part C of FIG. 3.

FIG. 6 is a schematic structural diagram of a sealing film according to an embodiment of the present disclosure.

### DETAILED DESCRIPTION OF THE EMBODIMENTS

Hereinafter, the technical solutions in the embodiments of the present disclosure will be clearly and completely described with reference to the accompanying drawings in the embodiments of the present disclosure, and it is obvious that the described embodiments are merely some embodiments of the present disclosure, rather than all embodiments. Based on the embodiments in the present disclosure, all other embodiments obtained by those skilled in the art without creative effort fall within the scope of protection of the present disclosure.

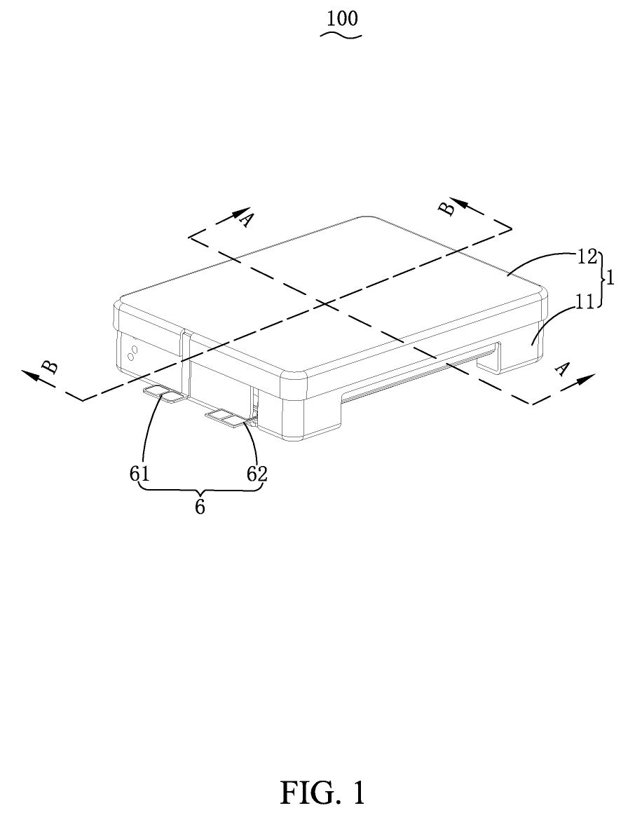

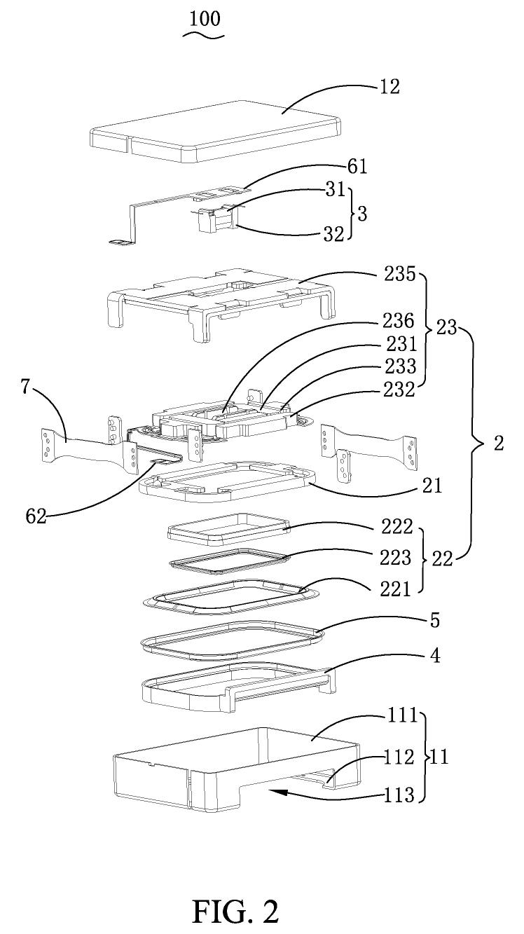

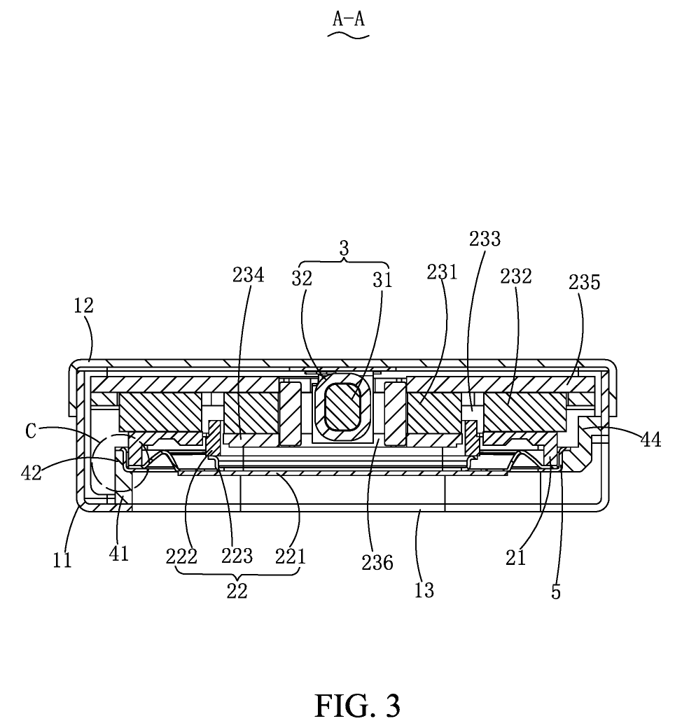

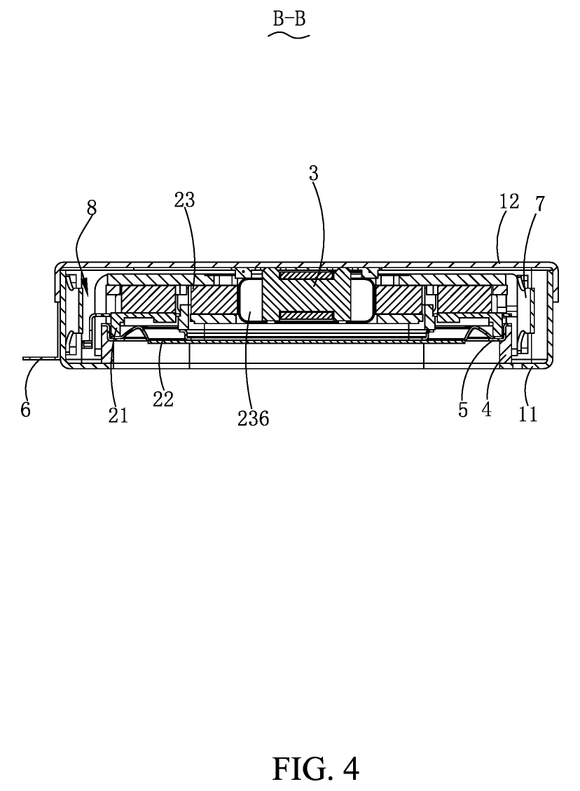

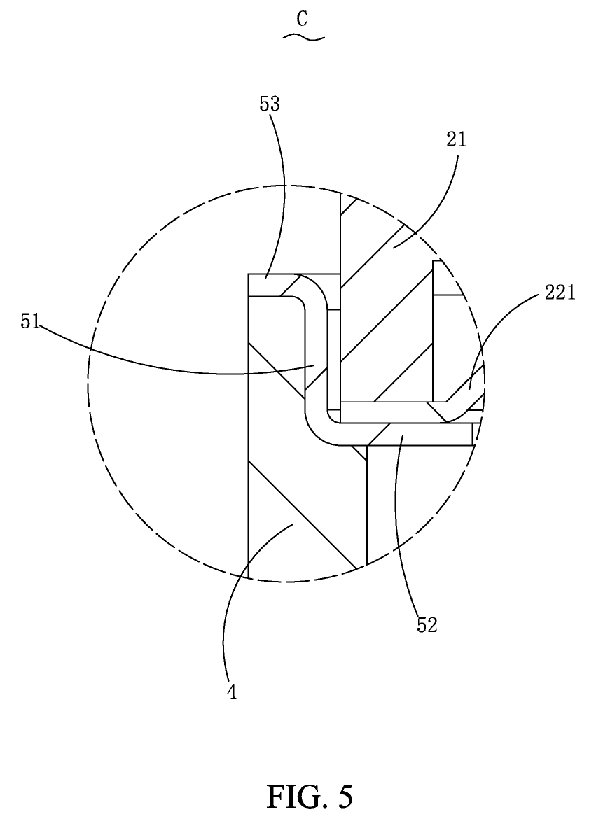

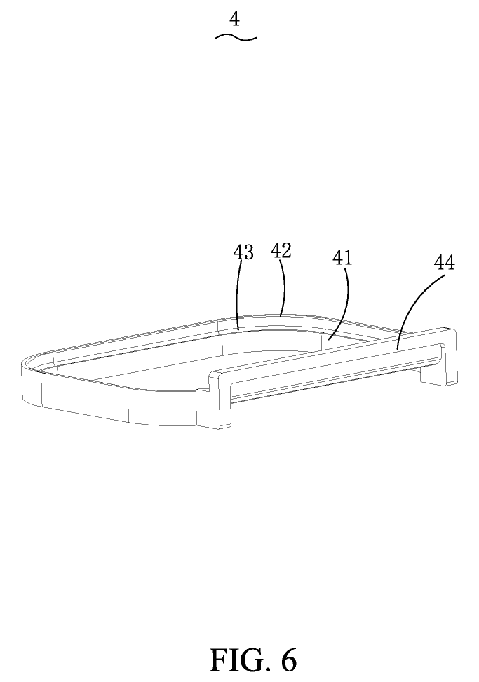

As shown in FIGS. 1 to 6, an embodiment of the present disclosure provides a multifunctional sound generating device 100, which includes a housing 1 having a receiving space, a sound generating unit 2 received in the receiving space, and at least one elastic member 7 configured to movably support the sound generating unit 2 in the housing 1. The sound generating unit 2 includes a basin frame 21, a vibration system 22 fixed to a side of two opposite sides of the basin frame 21, and a magnetic circuit system 23 fixed to another side of the two opposite sides of the basin frame 21. The magnetic circuit system 23 is configured to drive the vibration system 22 to vibrate and output sound. The housing 1 defines an opening 13 through which the sound from the sound generating unit 2 can be output. The multifunctional sound generating device 100 further includes a driving coil 3 fixed to the housing 1. The driving coil 3 interacts with the magnetic circuit system 23 to drive the sound generating unit 2 to move back and forth in a direction perpendicular to a vibration direction of the vibration system 22.

The housing 1 includes a first housing 11 having a hollow structure and a second housing 12 covered and fixed to the first housing 11, and the driving coil 3 is configured to drive the sound generating unit 2 to vibrate. The sound generating unit 2 is fixed to a side of the first housing 11 close to the second housing 12. The driving coil 3 is fixed to the second housing 12 and suspended in the sound generating unit 2. The sound generating unit 2 and the first housing 11 are fixedly connected by providing elastic members 7 on both opposite sides of the sound generating unit 2, so that the sound generating unit 2 is suspended in the receiving space of the housing 1 and can move back and forth (reciprocate) in a direction perpendicular to a vibration direction of the vibration system 22. Optionally, there are two elastic members 7 provided on two opposite sides of the sound generating unit 2. Each of the two elastic members 7 may be a structure such as an elastic piece, an elastic arm, or the like.

The driving coil 3 includes a core 31 and a winding 32 wound around the core 31. The sound generating unit 2 defines a through hole 236. The core 31 is fixed to the second housing 12 and positioned in the through hole 236.

The vibration system 22 includes a diaphragm 221 fixed to the basin frame 21, and a vibrating voice coil 222 configured to drive the diaphragm 221 to vibrate. The multifunctional sound generating device 100 further includes an annular sealing film 4, the sealing film 4 is connected to the housing 1 and the sound generating unit 2, and the diaphragm 221, the sealing film 4, and the housing 1 cooperatively define a closed rear cavity 8. The sealing film 4 may be deformed when the sound generating unit 2 moves back and forth in the direction perpendicular to the vibration direction of the vibration system 22. By utilizing the weight of the sound generating unit 2 to provide the mass effect of the motor vibrator, the overall installation space is saved. In addition, by connecting the sealing film 4 to the housing 1 and the sound generating unit 2, the diaphragm 221, the sealing film 4, and the housing 1 define the closed rear cavity 8. Furthermore, the sealing film 4 can be deformed when the sound generating unit 2 moves back and forth in the direction perpendicular to the vibration direction of the vibration system 22, so that the sealing film 4 can be deformed and can play a role of isolating the air and sound pressure of the front cavity and the rear cavity 8, thereby further improving the acoustic performance of the multifunctional sound generating device 100. The magnetic circuit system 23 has a magnetic gap 233, the vibrating voice coil 222 is inserted into and disposed in the magnetic gap 233, and the through hole 236 runs through the magnetic circuit system 23.

In the present embodiment, the sealing film 4 and the housing 1 are integrally formed or fixedly connected by adhesive bonding. Therefore, the structural strength of the housing 1 and the sealing film 4 can be improved.

In the present embodiment, the vibration system 22 further includes a skeleton 223, and the skeleton 223 has an end of both ends fixed to the diaphragm 221 and another end of the both ends fixed to the vibrating voice coil 222.

In the present embodiment, hardness of the sealing film 4 is less than 30 A (e.g., Rockwell Hardness A scale).

In the present embodiment, the sealing film 4 is made of one or more materials of silica gel, rubber, and elastomer. By making the sealing film 4 of a polymer material such as silica gel, rubber, or elastomer, the hardness of the sealing film 4 is less than 30 A, and thus, the sealing film 4 can be deformed in X and Y directions, or in X, Y, and Z directions, so as to isolate the diaphragm 221 from the sound pressure of the front cavity and the rear cavity 8. The X and Y directions are directions perpendicular to the vibration direction of the vibration system 22, and the Z direction is the vibration direction of the vibration system 22.

The sealing film 4 is made of a polymer material, so that the entire sealing film 4 can be deformed, to provide a damping effect for the sound generating unit 2, such that the vibration performance is good.

In the present embodiment, the first housing 11 of the housing 1 includes an annular frame 111, a bottom wall 112 formed by bending and extending one end of the frame 111 in a direction close to the sound generating unit 2, and an avoidance space 113 formed by running through one side surface of the frame 111. The sealing film 4 has a side that is close to the bottom wall 112 fixed to the bottom wall 112, and has another side that is close to the avoidance space 113 fixed to the frame 111. The first housing 11 is rectangular as a whole. The two elastic members 7 are located on short edges of the frame 111, respectively. The avoidance space 113 is provided in any of two long edges of the frame 111. The opening 13 can be defined on the bottom wall 112 corresponding to the diaphragm 221 to realize the front sound generation of the sound generating unit. The opening 13 may also be defined on the frame 111. In this case, the diaphragm 221, the sealing film 4, and the bottom wall 112 define a front cavity for outputting the sound of the sound generating unit 2, and the sound can be outputted through the front cavity and the opening 13 provided on the frame 111 to realize side sound generation. In this case, optionally, the avoidance space 113 may act as the opening 13.

In the present embodiment, the sealing film 4 includes an annular sealing film body 41 fixed to the bottom wall 112, an annular support portion 42 formed by extending from one end of the sealing film body 41 away from the bottom wall 112, and a step portion 43 formed by recessing from a side of the support portion 42 close to the sound generating unit 2 in a direction away from the sound generating unit 2. A part of the support portion 42 corresponding to the avoidance space 113 bends in a direction toward the avoidance space 113 and then extends in a direction toward the avoidance space 113 to form a bent portion 44, and one end of the bent portion 44 away from the sound generating unit 2 is fixed to the frame 111.

In the present embodiment, the multifunctional sound generating device 100 further includes an annular sealing ring 5. The sealing ring 5 has an inner side fixed to the sound generating unit 2 and has an outer side fixed to the sealing film 4. The sealing performance of the sealing film 4 is increased by the sealing ring 5, and the air and sound pressure of the front cavity and the rear cavity 8 can be better isolated.

In the present embodiment, the sealing ring 5 includes an annular sealing ring body 51 fixed to the step portion, a first connection portion 52 formed by bending and extending from an end of the sealing ring body 51 close to the bottom wall toward the sound generating unit, and a second connection portion 53 formed by bending and extending from another end of the sealing ring body 51 away from the bottom wall toward the frame 111. The first connection portion 52 is fixed to the sound generating unit 2, and the second connection portion 53 is fixed to an end of the support portion 42 away from the sealing film body 41. The sealing performance between the sealing film body 41 and the sound generating unit 2 can be increased.

In the present embodiment, the first connection portion 52 is fixed to the diaphragm 221. The sealing ring body 51 extends along the vibration direction of the vibration system 22 and is spaced apart from the basin frame 21 in the direction perpendicular to the vibration direction of the vibration system 22, so that the sound generating unit 2 can better realize vibration.

In the present embodiment, the sealing ring 5 has a longitudinal cross section of a Z-shaped structure or an S-shaped structure. The shape of the sealing ring 5 can be determined according to actual needs.

In this embodiment, the multifunctional sound generating device 100 further includes a conductive member 6. The conductive member 6 is connected with the driving coil 3 and/or the vibrating voice coil 222 and is configured to introduce an external electrical signal for the driving coil 3 and/or the vibrating voice coil 222.

In the present embodiment, the conductive member 6 includes a first conductive member 61 and a second conductive member 62. The first conductive member 61 has an end that is fixed to the driving coil 3 and forms an electrical connection with the driving coil 3, and has the other end that extends to outside of the housing 1 for connecting external devices. The second conductive member 62 has an end that is fixed to the vibrating voice coil 222 and forms an electrical connection with the vibrating voice coil 222, and has the other end that extends to the outside of the housing 1 for connecting external devices.

Alternatively, the conductive member 6 may be a flexible printed circuit (FPC) plate or the like.

In the present embodiment, the magnetic circuit system 23 includes a magnetic bowl 235 fixed to the elastic members 7, a main magnet assembly 231 stacked and fixed to a side of the magnetic bowl 235 close to the vibration system 22, and an auxiliary magnet 232 surrounding the main magnet assembly 231. The main magnet assembly 231 defines the through hole 236 that runs through the main magnet assembly 231, and a side of the auxiliary magnet 232 close to the vibration system 22 is fixed to the basin frame 21. The magnetic bowl 235 is configured to support and fix the main magnet assembly 231 and the auxiliary magnet 232. The main magnet assembly 231 is driven to vibrate in the direction perpendicular to the vibration direction by the driving coil 3, so as to improve the vibration performance of the overall multifunctional sound generating device 100.

In the present embodiment, the multifunctional sound generating device 100 further includes a pole core 234 stacked and fixed to the main magnet assembly 231. The magnetism of the main magnet assembly 231 can be enhanced by the pole core 234, and the magnetic circuit performance of the main magnet assembly 231 and the auxiliary magnet 232 can be improved.

Compared with the related technologies, in the multifunctional sound generating device of the present disclosure, the sound generating unit is movably supported in the housing by the elastic members, and the housing defines the opening for outputting sound of the sound generating unit. The multifunctional sound generating device further includes the driving coil fixed on the housing, the driving coil interacts with the magnetic circuit system to drive the sound generating unit to move back and forth in the direction perpendicular to the vibration direction of the vibration system to realize the vibration of the sound generating unit. In addition, the mass effect of the motor vibrator is provided by using the weight of the sound generating unit to save the overall installation space. By connecting the sealing film with the housing and the sound generating unit, the closed rear cavity is formed between the diaphragm, the sealing film, and the housing. The sealing film can deform when the sound generating unit moves back and forth in the direction perpendicular to the vibration direction of the vibration system, so that the sealing film can not only deform, but also play the role of isolating the air and sound pressure in the front cavity and the rear cavity, further improving the acoustic performance of the multifunctional sound generating device.

The above illustration is merely embodiments of the present disclosure, and it shall be pointed out here that those skilled in the art can make improvements without departing from the inventive concept of the present disclosure, but these are all within the scope of protection of the present disclosure.

What is claimed is:

1. A multifunctional sound generating device, comprising:
a housing having a receiving space, a sound generating unit received in the receiving space, and at least one elastic member configured to movably support the sound generating unit in the housing; wherein the sound generating unit includes a basin frame, a vibration system fixed to a side of two opposite sides of the basin frame, and a magnetic circuit system fixed to another side of the two opposite sides of the basin frame, wherein the magnetic circuit system is configured to drive the vibration system to vibrate and output sound, and the housing defines an opening for outputting the sound of the sound generating unit;
wherein the multifunctional sound generating device further includes a driving coil fixed to the housing, and the driving coil interacts with the magnetic circuit system to drive the sound generating unit to move back and forth in a direction perpendicular to a vibration direction of the vibration system; and
wherein the vibration system includes a diaphragm fixed to the basin frame and a vibrating voice coil configured to drive the diaphragm to vibrate, the multifunctional sound generating device further includes an annular sealing film, and the sealing film is connected to the housing and the sound generating unit, and wherein the diaphragm, the sealing film, and the housing cooperatively define a closed rear cavity, and the sealing film is deformable on condition that the sound generating unit moves back and forth in the direction perpendicular to the vibration direction of the vibration system.

2. The multifunctional sound generating device of claim 1, wherein the sealing film has hardness less than 30A.

3. The multifunctional sound generating device of claim 1, wherein the sealing film is made of at least one of silica gel, rubber, and elastomer.

4. The multifunctional sound generating device of claim 1, wherein the housing includes a first housing having a hollow structure and a second housing covered and fixed to the first housing, and the driving coil is configured to drive the sound generating unit to vibrate; wherein the sound generating unit is fixed to a side of the first housing close to the second housing, and the driving coil is fixed to the second housing and suspended in the sound generating unit.

5. The multifunctional sound generating device of claim 4, wherein the driving coil includes a core and a winding wound around the core, the sound generating unit defines a through hole, and the core is fixed to the second housing and positioned in the through hole.

6. The multifunctional sound generating device of claim 4, wherein the first housing includes an annular frame, a bottom wall formed by bending and extending one end of the frame in a direction close to the sound generating unit, and an avoidance space formed by running through one side surface of the frame;
wherein the sealing film has a side that is close to the bottom wall fixed to the bottom wall and has another side that is close to the avoidance space fixed to the frame.

7. The multifunctional sound generating device of claim 6, wherein the sealing film includes an annular sealing film body fixed to the bottom wall, an annular support portion formed by extending from one end of the sealing film body away from the bottom wall, and a step portion formed by recessing from a side of the support portion close to the sound generating unit in a direction away from the sound generating unit; wherein the support portion bends and extends in a direction toward the avoidance space at a portion of the support portion corresponding to the avoidance space to form a bent portion, and the bent portion is fixed to the frame at an end of the bent portion away from the sound generating unit.

8. The multifunctional sound generating device of claim 7, wherein the multifunctional sound generating device further includes an annular sealing ring, and the sealing ring has an inner side fixed to the sound generating unit and has an outer side fixed to the sealing film.

9. The multifunctional sound generating device of claim 8, wherein the sealing ring includes an annular sealing ring body fixed to the step portion, a first connection portion formed by bending and extending from an end of the sealing ring body close to the bottom wall toward the sound generating unit, and a second connection portion formed by bending and extending from another end of the sealing ring body away from the bottom wall toward the frame; wherein the first connection portion is fixed to the sound generating unit, and the second connection portion is fixed to an end of the support portion away from the sealing film body.

10. The multifunctional sound generating device of claim 9, wherein the first connection portion is fixed to the diaphragm, and the sealing ring body extends along the vibration direction of the vibration system and is spaced apart from the basin frame in the direction perpendicular to the vibration direction of the vibration system.

11. The multifunctional sound generating device of claim 1, wherein the sealing film and the housing are integrally formed or fixedly connected by adhesive bonding.

12. The multifunctional sound generating device of claim 1, wherein the multifunctional sound generating device further comprises a conductive member, wherein the conductive member is connected with at least one of the driving coil and the vibrating voice coil, and configured to introduce an external electrical signal for the at least one of the driving coil and the vibrating voice coil.

13. The multifunctional sound generating device of claim 12, wherein the conductive member includes a first conductive member and a second conductive member, the first conductive member has an end that is fixed to the driving coil and forms an electrical connection with the driving coil, and has the other end that extends to outside of the housing for connecting external devices; wherein the second conductive member has an end that is fixed to the vibrating voice coil and forms an electrical connection with the vibrating voice coil, and has another end that extends to the outside of the housing for connecting external devices.

14. The multifunctional sound generating device of claim 6, wherein the opening is defined on the bottom wall or the frame.

15. The multifunctional sound generating device of claim 1, wherein the magnetic circuit system includes a magnetic bowl fixed to the at least one elastic member, a main magnet assembly stacked and fixed to a side of the magnetic bowl close to the vibration system, and an auxiliary magnet surrounding the main magnet assembly, wherein the main magnet assembly defines a through hole that runs through the main magnet assembly, a side of the auxiliary magnet close to the vibration system is fixed to the basin frame, and the magnetic bowl is configured to support and fix the main magnet assembly and the auxiliary magnet.

16. The multifunctional sound generating device of claim 15, wherein the magnetic circuit system has a magnetic gap, the vibrating voice coil is inserted into and disposed in the magnetic gap, and the through hole runs through the magnetic circuit system.
